(19) United States
(12) Patent Application Publication
(10) Pub. No.: US 2018/0240065 A1
(43) Pub. Date: Aug. 23, 2018

(54) SECURE PACKAGE DELIVERY

(71) Applicant: Cybaseal, Ltd., Surrey (GB)

(72) Inventors: Ethan Hilsley, Surrey (GB); Barrington Hilsley, Surrey (GB)

(21) Appl. No.: 15/901,793

(22) Filed: Feb. 21, 2018

Related U.S. Application Data
(60) Provisional application No. 62/461,661, filed on Feb. 21, 2017.

(51) Int. Cl. G06Q 10/08; G06K 19/06

(52) U.S. Cl. CPC G06Q 10/0832; G06K 19/06037

(57) ABSTRACT

Systems and methods are described for package delivery tracking. A mobile computing device executing a software application may capture information regarding a target package and regarding tamper-resistant materials used to seal the target package. The system may further obtain a package delivery workflow and package monitoring criteria, which may specify that the target package be received within a particular geofence, delivered via a specified delivery route, delivered before a specified time, or within a specified window, delivered to a specified location, or that other environmental conditions be maintained. Delivery of the target package may then be monitored to ensure that the delivery workflow is followed and the criteria for package delivery are satisfied, and the package may be verified upon receipt to ensure compliance with the workflow and that the package was not tampered with in transit.

### INCORPORATION BY REFERENCE TO RELATED APPLICATIONS

Any and all applications identified in a priority claim in the Application Data Sheet, or any correction thereto, are hereby incorporated by reference herein and made a part of the present disclosure.

### BACKGROUND

Delivery tracking systems can be used to ensure accuracy and integrity of deliveries from one location to another. The objects to be delivered may be valuable, fragile, and/or may have specific handling requirements to prevent spoilage or damage, such as refrigeration or a particular spatial orientation (e.g., “this end up”). Objects may be packaged in a container to ensure that handling requirements are met or to prevent incidental damage during shipment. To further ensure that the object is secure during transit, the package may be sealed using tamper-resistant seals or other materials.

Packages may be delivered by a package delivery service, which may employ truck drivers or other couriers specifically for that purpose. Increasingly, packages may be delivered by informal or crowdsourced couriers, such as drivers of ride-sharing services or members of vehicle-sharing services. An individual delivery agent may thus be unknown and untrusted by the sender and receiver of the package.

### SUMMARY

Aspects of the present disclosure include a package delivery system that verifies the delivery of a package and confirms that specified criteria were met during the delivery. In various embodiments, a software application may be used in conjunction with tamper-resistant packaging and/or various sensors to verify the integrity of a package, confirm that the package was delivered to the correct location, monitor and confirm the delivery route, verify that the package was delivered in accordance with various delivery criteria, and otherwise ensure that the package was delivered securely.

In some embodiments, the system includes tamper-resistant packaging such as shrink wraps, lids, straps, and seals, any or all of which may contain data that is readable by a computing device. For example, the system may include a roll of shrink wrap having a sequence of scannable codes printed along its length, the software application may thus scan the roll before and after it is used to wrap a package, determine starting and ending codes for the material that was used, and associate these codes with the shrink-wrapped package. The software application may then verify the starting and ending codes when the package is delivered to its destination.

In some embodiments, the software application may be implemented on a mobile computing device (e.g., a smartphone, tablet, or other device carried by a driver), which may be transported with the package. The software application may use the mobile computing device's sensors (and/or other embedded sensors that are in communication with the mobile computing device) to monitor the package, the delivery route, the time of delivery, or other environmental factors, and may verify that these factors meet various criteria.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 depicts a schematic block diagram of an illustrative environment including a sealed package and a mobile computing device that communicates with a data store via a network.

FIG. 2A is an illustrative block diagram depicting capture of information regarding a package that is sealed by a sender and provided to a courier for delivery.

FIG. 2B is an illustrative block diagram depicting verification of information regarding a package that is delivered to a recipient.

FIG. 3A is an illustration of a tamper-resistant packaging material.

FIG. 3B is an illustration of tamper-resistant packaging being applied to a package and utilized by a software application in accordance with the present disclosure.

FIG. 3C is an illustration of a tamper-resistant label applied to a package.

FIG. 3D is an illustration of a tamper-resistant bolt that may be utilized in aspects of the present disclosure.

FIG. 4 is a flow diagram depicting an illustrative package sealing routine.

FIG. 5 is a flow diagram depicting an illustrative package delivery monitoring routine.

FIG. 6 is a flow diagram depicting an illustrative package verification routine.

### DETAILED DESCRIPTION

Generally described, aspects of the present disclosure relate to package delivery tracking. More specifically, aspects of the present disclosure are directed to systems, methods, and computer-readable media related to monitoring and characterizing compliance with a specified workflow related to the delivery of packages. Illustratively, a workflow may define a set of events related to the establishment of a package for delivery by a supplier/vendor, one or more modes of transit and intermediaries, and culminating with the delivery of the package at a specified recipient location. The workflow can further identify one or more information collection events and corresponding information that can be utilized to characterize compliance with the series of events and further to determine whether there is a likelihood that the package has been opened, modified or inappropriately accessed. As will be explained in detail below, the implementation of the workflow can utilize a combination of mobile computing devices, location positioning systems, physical devices (e.g., tamper-resistant materials) and data processing applications.

By way of an illustrative workflow, a mobile computing device carried by a driver or other courier, generally referred to as the delivery vendor, may be configured to execute a software application. The software application may authenticate the driver and may collect data associated with receipt of the target package for delivery, such as the location and time at which the driver takes possession, the weight or size of the package, information regarding tamper-resistant materials used to secure the package, and other information. In some embodiments, the software application may collect data by utilizing native functionality of the mobile computing device. For example, the data can include information identifying the delivery vendor, the information identifying the supplier/vendor providing the target package, location information associated with the current location of the delivery vendor, timing information associated with receipt of the target package, information identifying the target package, information verifying a state of the target package (such as unopened), and the like. The software application may collect data associated with the target package via Bluetooth, WiFi, GPS or other geolocation system, RFID, a camera, a wand or scanner, or other wired or wireless interface of the mobile computing device. In further embodiments, the software application may receive data regarding the target package via a touchscreen, keyboard, stylus, pointing device, or other input device.

As generally described above, the software application may, in some embodiments, associate the target package with information verifying a state of the target package. More specifically, state information can include a set of sequence numbers or other identifying marks of a tamper-resistant packing material. Illustratively, the set of sequence numbers or other identifying marks can include at least one set of visible codes that can be scanned, read, or otherwise received without opening the target package or destroying/modifying the packaging. In one example, the package may be physically secured using a lid, which may be printed with at least one visible code or identifier. The software application may scan (or otherwise obtain) the code when the lid is attached and the package is ready for shipment. As a further example, as described above, the package may be wrapped using a tamper-resistant shrink wrap that has visible codes or sequence numbers along its length. Still further, the package may be secured with straps or ties, which may have visible codes or identifiers along their length, and each strap may be sealed using a seal, which may in turn have its own unique code. In some embodiments, the visible codes for each packing material may be unique only within that material (e.g., no two lids have the same visible code, but a lid and a seal could have the same code). In other embodiments, the visible codes may be assigned in such a manner that individual packages may be assigned to a distinct set of codes. Still further, in some embodiments, codes may be reused if the possibility of confusion is sufficiently low. For example, sequence numbers may be repeated after a sufficient time has elapsed, or if other factors (e.g., distance, method of transport, etc.) would make confusion of target packages unlikely.

With continued reference to the illustrative workflow, once the delivery vendor takes possession of the target package, the software application on the mobile computing device may monitor various environmental conditions and provide information in accordance with the workflow and with specified criteria. For example, the specified workflow may include geographic parameters that specify a geographic area, such as a geofence, in which the delivery vendor can receive the target package. In this example, any information indicating that the target package was received outside of the defined geographic parameters can be indicative of a violation of the workflow or indicative of the potential for tampering. In another example, the software application can specify a delivery route to the destination, or the criteria may indicate that the target package should be delivered within a specified time period (e.g., before 10:00 a.m.) or within a delivery window (e.g., during business hours). Illustratively, the interfaces provided by the software application may be modified or customized in accordance with language preferences of the delivery vendor. The software application can also collect information, such as passport information, visa information or other information that may be necessary for the delivery or that may be collected as part of the workflow.

In some embodiments, the software application may monitor sensors associated with the delivery vehicle in order to verify workflows and criteria. For example, the software application may monitor the temperature of a vehicle's cargo area to verify that the temperature is within a range or satisfies a threshold. As a further example, the application may monitor the gross weight of the vehicle or its cargo area to verify that the package remains in the vehicle, that the driver picks up or delivers packages according to the workflow, or to detect that the driver is making unscheduled pick-ups or deliveries. In further embodiments, the software application may use the data it collects to track vehicle inventory as pick-ups and deliveries occur. The application may thus provide an inventory report to confirm that the driver has completed a set of pick-ups and deliveries in a specified order, or to facilitate off-loading packages at a destination or a distribution center.

In one embodiment, the software application may verify that the target package is on the delivery route, and that the delivery is progressing toward the destination at a rate that would satisfy the criteria. In some embodiments, the criteria may specify an acceptable amount of deviation. For example, the criteria may permit alternate delivery routes, or the application may monitor traffic or weather conditions and determine an acceptable delay. In some embodiments, the software application may provide information to the driver, such as a warning notice, if it detects that a workflow is not being followed or that a criterion is not satisfied (or is about to become unsatisfied). In further embodiments, the software application may provide a notification to the sender, the recipient, an employer of the driver, or another party when the workflow is not followed or the criteria are not met.

The software application may, in some embodiments, detect that the delivery vehicle is entering or leaving a controlled area. For example, the software application may detect via GPS that the vehicle is crossing an international boundary and entering a customs inspection point. The software application may thus generate a manifest, regulatory paperwork, or other information to facilitate crossing the border and completing the inspection. In further embodiments, the software application may determine an appropriate language in which to generate the paperwork. For example, the software application may determine that the vehicle is crossing the border into Spain, and may translate the vehicle inventory into Spanish and generate the border crossing paperwork required by the Spanish government. In this example, the software application may utilize passport, visa, or other information previously collected.

The software application may also confirm that the package is picked up or delivered to (or within a specified range of) a specified geographic location. For example, a workflow associated with package deliveries may include picking up a first package at a first location, picking up a second package at a second location, dropping off the second package at a third location, and then dropping off the first package at a fourth location. The software application may therefore determine a workflow violation if the first package is dropped off anywhere other than the fourth location, and in some embodiments may provide a warning if and when this happens.

Upon arrival at the destination, the software application may re-authenticate the driver, or in some embodiments may authenticate the recipient. The software application may then re-scan the package and any tamper-resistant packaging to confirm that the seals are unbroken and the packaging has not been tampered with. In some embodiments, the tamper-resistant seal may incorporate an identifier that is hidden and unreadable without removing the seal, and the recipient may break the seal, reveal the hidden identifier, and provide the hidden identifier as a confirmation code. The software application may further verify to the recipient whether the workflow and delivery conditions were satisfied while the package was in transit, and thus indicate to the recipient whether the package should be accepted. In further embodiments, the software application may verify to the recipient that the delivery complied with geographic parameters of the workflow. For example, the software application may verify to the recipient that the target package was received by the delivery vendor within the geofence, or that a delivery route specified by the workflow was followed.

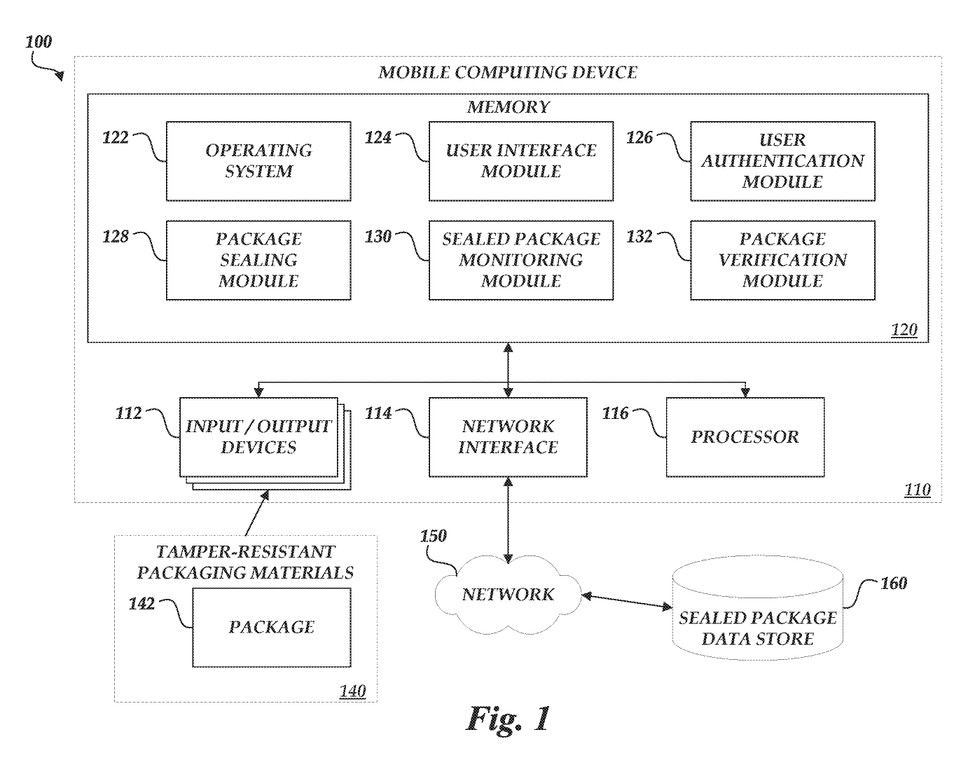

FIG. 1 depicts a schematic block diagram of an illustrative environment 100 for implementing aspects of the present disclosure. The illustrated environment 100 includes a mobile computing device 110, which communicates with a sealed package data store 160 via a network 150. The illustrated environment 100 further includes a package 142 that is sealed using tamper-resistant packaging materials 140, which may be scanned or read by the mobile computing device 110.

The mobile computing device 110 may generally be any computing device that implements aspects of the present disclosure as described herein. While the term “mobile” is used in reference to the mobile computing device 110, the mobile computing device 110 should not be construed as limited to devices equipped for mobile communication. Rather, examples of a mobile computing device 110 include, but are not limited to, smartphones, tablet computers, laptops, personal computers, wearable computing devices, personal digital assistants (PDA)s, hybrid PDA/mobile phones, electronic book readers, digital media players, integrated components for inclusion in computing devices, appliances, electronic devices for inclusion in vehicles or machinery, gaming devices, set top boxes, electronic devices for inclusion in televisions, voice-controlled devices, and the like.

The mobile computing device 110 includes various components and modules for implementing aspects of the present disclosure. One skilled in the art will understand that FIG. 1 is provided as an example, and that the mobile computing device 110 may contain more or fewer components and modules than those illustrated, and further that the components and modules may be combined or divided in various embodiments. In the illustrated embodiment, the mobile computing device includes a processor 116, a network interface 114, and a number of input/output devices 112, all of which may communicate with one another by way of a communication bus. The network interface 114 may provide connectivity to one or more networks (such as the network 150) and, as a result, may enable the mobile computing device 110 to send and receive information and instructions to and from other computing systems or services.

The processor 116 may also communicate to and from a memory 120. The memory 120 may contain computer program instructions (grouped as modules or components in some embodiments) that the processor 116 may execute in order to implement one or more embodiments. The memory 120 generally includes RAM, ROM, and/or other persistent, auxiliary, or non-transitory computer-readable media. The memory 120 may store an operating system 122 that provides computer program instructions for use by the processor 116 in the general administration and operation of the mobile computing device 110. The memory 120 may further store specific computer-executable instructions and other information (which may be referred to herein as “modules”) for implementing aspects of the present disclosure. For example, the memory 120 may include a user interface module 124, which may be executed by the processor 116 to perform various operations with regard to displaying the user interfaces described herein.

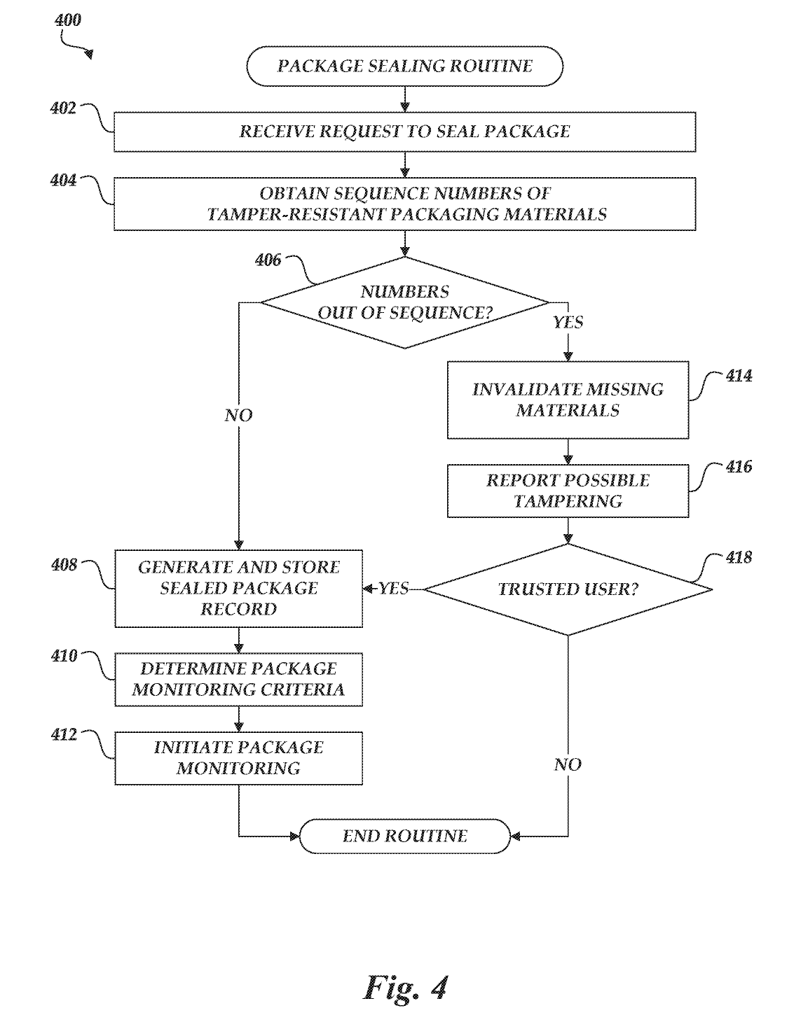

In some embodiments, the memory 120 may include a user authentication module 126, which may be executed by the processor 116 to authenticate users of the mobile computing device 110, as described below. The memory 120 may further include a package sealing module 128, which may be executed by the processor 116 to collect information relating to a sealed package, a sealed package monitoring module 130, which may be executed to perform monitoring functions for a package in transit, and a package verification module 132, which may be executed to verify that a package was delivered securely and in accordance with specified workflows and criteria. The operations of the package sealing module 128, sealed package monitoring module 130, and package verification module 132 are described in more detail below with respect to FIGS. 4, 5, and 6 respectively.

In some embodiments, the user interface module 124, user authentication module 126, package sealing module 128, sealed package monitoring module 130, and package verification module 132 may be implemented or presented as a single software application executing on the mobile computing device 110. In other embodiments, although illustrated in FIG. 1 as distinct modules in the memory 120, some or all of the modules 124-132 may be incorporated as modules in the operating system 122 or another application or module, and, as such, separate modules may not be required to implement some embodiments.

It will be recognized that many of the components described above are optional, and that embodiments of the mobile computing device 110 may or may not combine the components. Furthermore, the devices and components described need not be distinct or discrete. For example, the mobile computing device 110 may be represented in a single physical device or, alternatively, may be split into multiple physical devices. In some embodiments, components illustrated as part of the mobile computing device 110 (such as the user authentication module 126) may additionally or alternatively be implemented by a networked computing device, such that some aspects of the present disclosure may be performed by the networked computing device while other aspects are performed by the mobile computing device 110.

The illustrated environment 100 further includes a sealed package data store 160, which is configured to store information relating to sealed packages. The sealed package data store 160 may illustratively be any non-transient computer readable data store, including but not limited to hard drives, solid state devices, flash memories, EEPROMs, optical media, and the like. The sealed package data store 160 communicates with the mobile computing device 110 via a network 150. The network 150 may illustratively be any wired or wireless network, including networks of networks such as the Internet.

The mobile computing device 110 may also collect information regarding tamper-resistant packaging materials 142 that are used to seal a package 140. The mobile computing device 110 may collect this information via a number of input/output devices 112, including but not limited to cameras, Bluetooth readers, RFID scanners, bar code scanners or wands, touchscreens and other user input devices, and the like. In some embodiments, the mobile computing device 110 may collect or receive information regarding the tamper-resistant packaging materials 140 via network 150 and network interface 114.

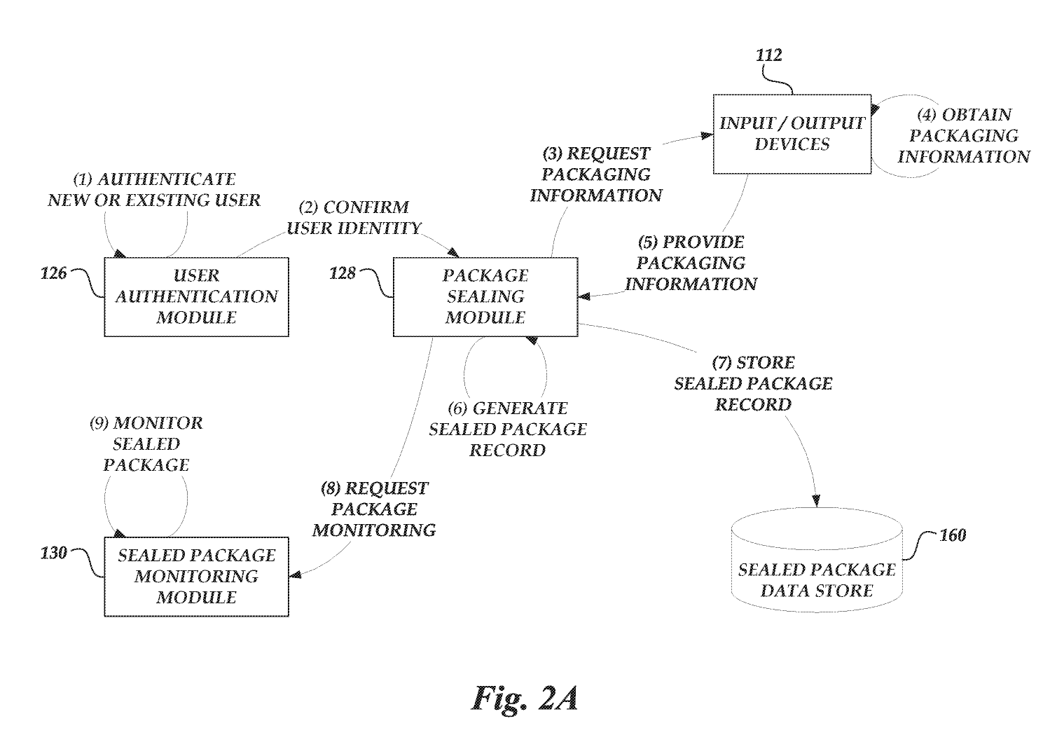

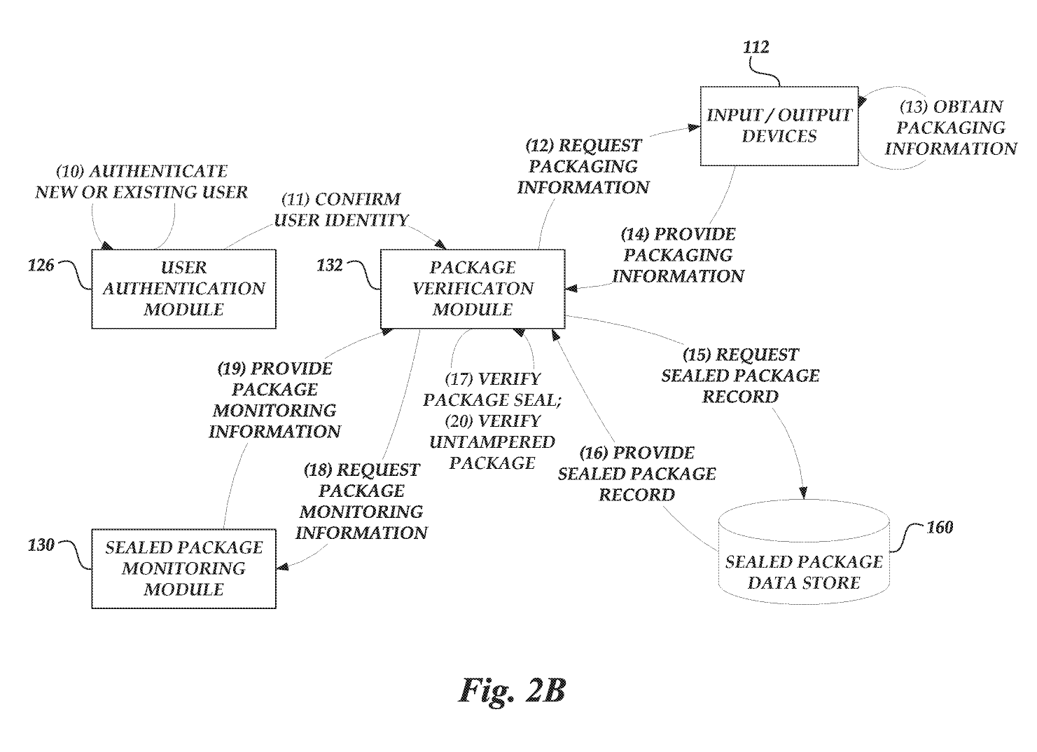

FIG. 2A is an illustrative block diagram depicting capture of information regarding a package and monitoring of environmental conditions during package delivery. In the illustrated embodiment, at (1), a new or existing user may be authenticated. The user may be authenticated, for example, by the user authentication module 126 of FIG. 1. In some embodiments, the user may be authenticated by retrieving user information from a data store, which may be implemented on the mobile computing device 110 of FIG. 1 or remotely. A new user may be prompted to generate information, such as a login ID and password, that will be used to authenticate that the user is the same user at a later time. In various embodiments, the user may be a driver or courier, a sender of the package, or another party.

At (2), the user's identity may be confirmed and the user may thus be allowed to scan a package for entry into the system. In various embodiments not depicted in FIG. 2A, the user may be presented with the option to scan a package, and may be further presented with other information, such as a list of packages currently associated with the user (e.g., because they were scanned by the user, or because the user has committed to deliver them) or information regarding the status of packages and their associated workflows and criteria.

At (3), the package sealing module 128 may initiate collection of packaging information via the input/output devices 112. Thereafter, at (4), the packaging information may be obtained. Illustratively, a camera, touchscreen, or other input/output device 112 may be used to scan a bar code, receive a sequence number as user input, receive data from an RFID chip or Bluetooth beacon, or otherwise collect any information that uniquely identifies the package and/or the materials used to seal the package. At (5), the package sealing module 128 receives the collected information from the input/output devices 112.

At (6), the package sealing module 128 may generate a sealed package record. The sealed package record may illustratively contain the information collected at (5), as well as other information associated with the package. For example, the sealed package record may include information regarding the sender, the recipient, the package contents, the courier, the time, and/or location of the courier taking possession, the expected delivery time, delivery route, package handling requirements, or other information. The package sealing module 128 may obtain such information by scanning a package label, obtaining sender or receiver preferences, receiving user input, or by other methods. At (7), the package sealing module 128 may store the sealed package record in a data store, such as the sealed package data store 160, for later retrieval.

At (8), the package sealing module 128 may request that the sealed package monitoring module 130 begin monitoring the sealed package. Thereafter, at (9), the sealed package monitoring module 130 may begin monitoring the sealed package, as described below in more detail.

With reference now to FIG. 2B, an illustrative block diagram depicting verification of a delivered package will be described. At (10), a new or existing user may be authenticated. In some embodiments, the user to be authenticated at (10) may be the driver, and the authentication that occurs may be comparable to the authentication at (1). In other embodiments, the recipient of the package may be authenticated. At (11), the user's identify may be confirmed, enabling verification of the received package.

At (12), the package verification module 132 may initiate collection of packaging information via the input/output devices 112. At (13) the packaging information may be obtained, in similar fashion as described with reference to FIG. 2A above. It will be understood that the packaging information obtained at (13) will include any information that can be derived from any sensor made available to the package verification module 132, and that the information obtained at (13) may be a subset or superset of the information obtained at (4) in FIG. 2A. At (14), the package verification module 132 receives the obtained information.

At (15), the package verification module 132 may request a sealed package record that corresponds to the information obtained at (14). Illustratively, the package verification module 132 may search or query the sealed package data store 160 for a corresponding record. At (16), the sealed package data store 160 may provide the sealed package record.

At (17), the package verification module 132 may compare the information obtained at (14) to the sealed package record obtained at (16) to verify that the tamper-resistant materials used to seal the package have not been tampered with. In some embodiments, as described above, a package seal or seals may contain a hidden code, which may be revealed by breaking the seal. The package verification module 132 may obtain the hidden code, for example as part of the sealed package record, and may instruct the recipient to break the seal and reveal the hidden code in order to verify the package. In some embodiments, if the package cannot be verified at (17), then the interactions at (18)-(20) may be omitted, and the package verification module 132 may generate an alert or other message indicating the seals appear to have been altered and the package cannot be verified.

At (18), the package verification module 132 may request package monitoring information from the sealed package monitoring module 130, which at (19) may provide the requested information. At (20), the package verification module 132 may analyze the package monitoring information to determine whether the package delivery criteria were met and/or that the package delivery workflow was followed. In some embodiments, the package verification module 132 at (18) may query the sealed package monitoring module 130 as to whether applicable criteria and workflows were satisfied, and the sealed package monitoring module 130 may indicate yes or no rather than providing monitoring data to be analyzed. If the package monitoring information indicates that delivery conditions were not met, then the package verification module 132 may generate a message to alert the recipient, and in some embodiments may instruct the recipient to refuse delivery.

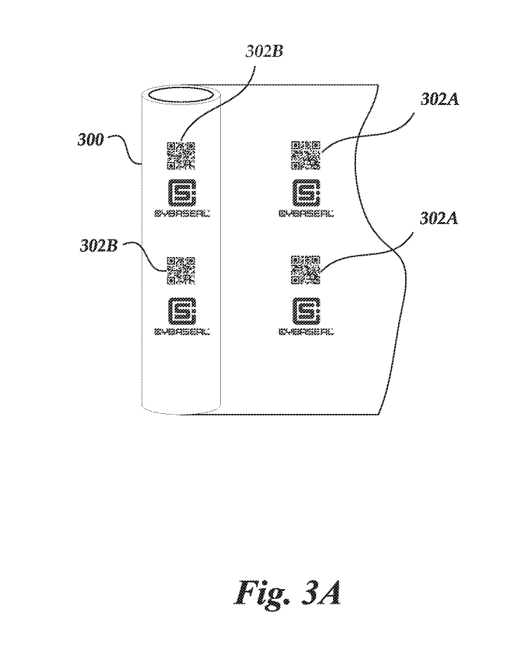

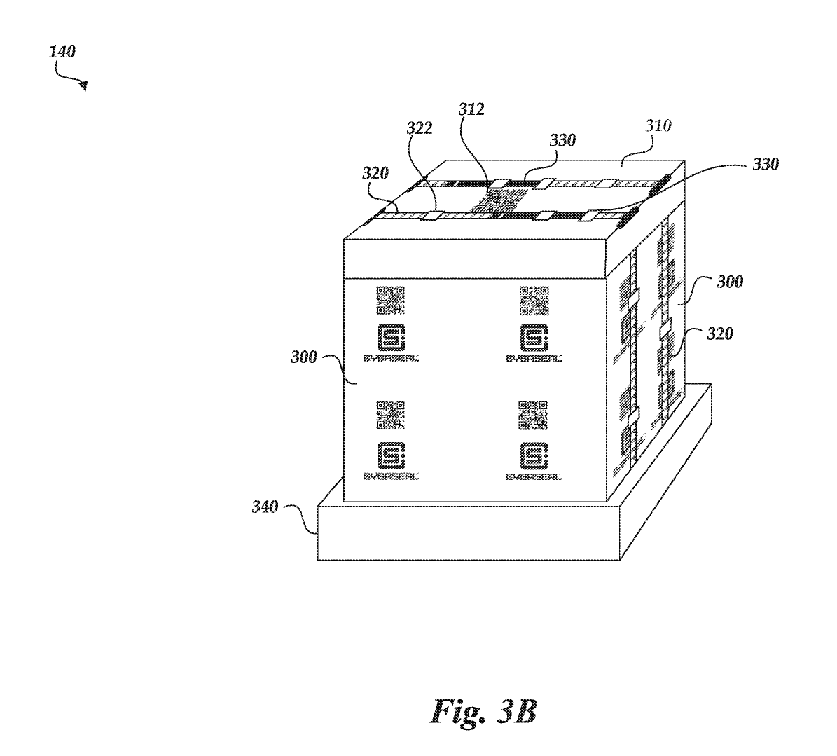

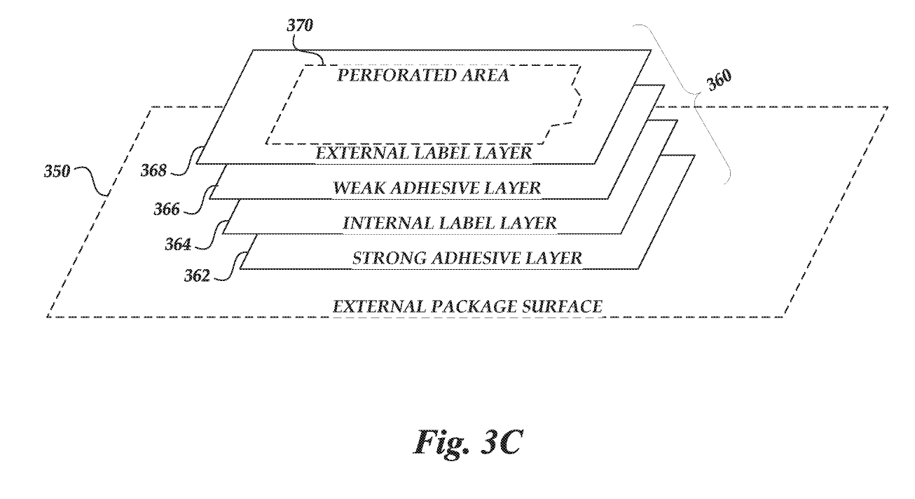

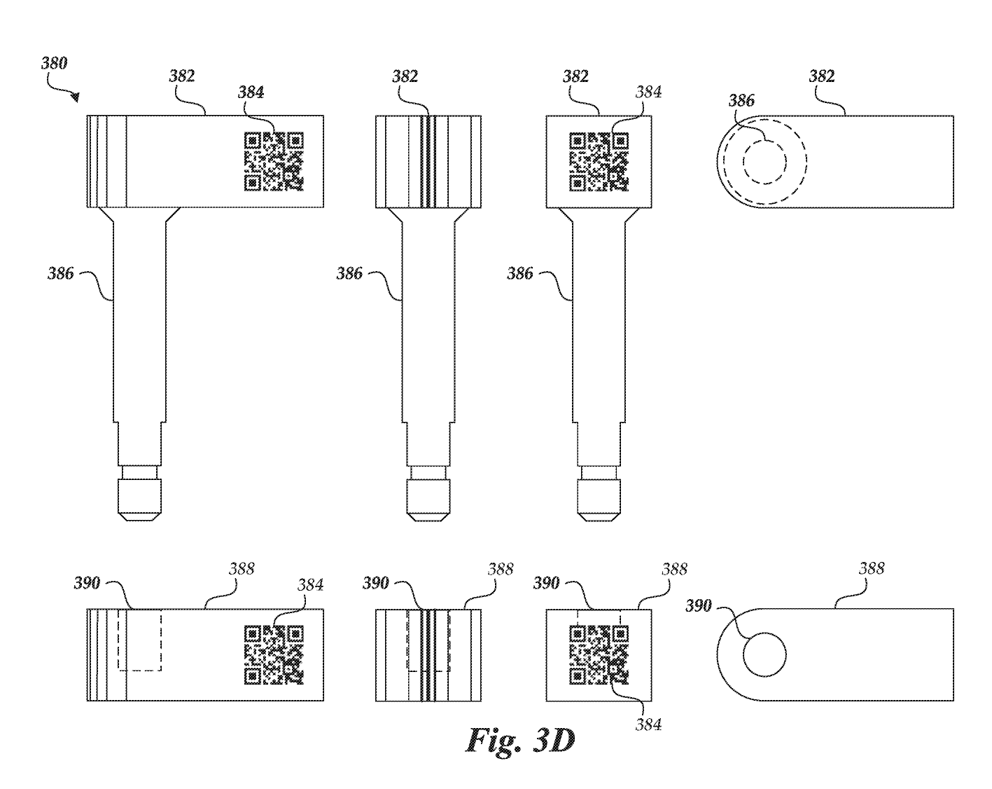

FIGS. 3A-D depict illustrative tamper-resistant packaging materials that, in some embodiments, may be used to securely seal a package. In various embodiments, the tamper-resistant packaging materials 140 depicted in FIG. 1 may include some or all of the packaging materials illustrated in FIGS. 3A-D. With reference now to FIG. 3A, a tamper-resistant shrink wrap 300 will be described. The shrink wrap 300 may include a series of printed codes, such as QR codes 302A and 302B, that may be read and used to identify a package, as described above. The printed codes may be sequential, random, or generated in accordance with an algorithm or other routine. Illustratively, the QR codes corresponding to the start and end of the portion of the shrink wrap 300 that is used to wrap a package may be associated with the package and used to identify the package. Alternatively, in some embodiments, the first QR code on the roll of shrink wrap 300 before wrapping the package and the first QR code that remains on the roll of shrink wrap 300 after wrapping the package may be used to identify the package.

Turning now to FIG. 3B, tamper-resistant materials for sealing a pallet 340 will be described. In the illustrated embodiment, the tamper-resistant materials include the shrink wrap 300 of FIG. 3A, a pallet lid 310, pallet straps 320, and cable seals 330. The tamper-resistant materials may be used, in some embodiments, to secure and seal a package or packages (such as package 142 of FIG. 1) to a pallet 340. For example, the shrink wrap 300 may be used to attach a package or packages to the pallet 340. As a further example, the pallet lid 310, pallet straps 320, and cable seals 330 may be used to secure a package or packages to the pallet 345. One skilled in the art will understand that the term “pallet” may interchangeably refer to the unloaded structure that is used to secure packages for transport, or to both the structure itself and the packages contained and sealed thereon.

The pallet lid 310 may, in some embodiments, be made of cardboard or another recyclable material. As illustrated in FIG. 3B, the pallet lid 310 may have holes or slots that allow the pallet straps 320 to pass through the pallet lid 310, thereby allowing the pallet lid 310 to be secured by the pallet straps 320. In some embodiments the pallet lid 310 may include a printed code, such as QR code 312, which further enables identification of the pallet 340. The QR code 312 may, in some embodiments, be associated with one or more of the QR codes 302A-B that are printed on the shrink wrap 300. For example, the QR code 312 may share a common prefix or identifier with the QR codes 302A-B, which may indicate that the pallet lid 310 and the shrink wrap 300 originated from the same location. In other embodiments, the QR code 312 on the pallet lid 310 may be independent of the QR codes 302A-B on the shrink wrap 300.

The pallet straps 320 may be used to secure the pallet lid 310 and/or the package(s) to the pallet 340. In some embodiments, the pallet straps 320 may be labeled with printed labels 322, which may function similarly to the QR codes 302A-B printed on the shrink wrap 300. In some embodiments, the printed labels 322 to the left and right of a cable seal 330 may be used to identify the pallet straps 320 that were used to secure a particular pallet 340, and the pallet straps 320 may be obtained from a longer length of strap that is marked with sequential printed labels 322 in similar fashion to the roll of shrink wrap 300.

A cable seal 330 may be used to tighten and secure each of the pallet straps 320, and may be affixed to the pallet strap 320 in a manner that creates a closed loop of the size that is needed to secure the pallet 340. The cable seal 330 may be labeled with one or more printed codes. In some embodiments, the cable seal 330 may be labeled with an externally visible printed code, which can be read while the pallet 340 is in transit, and a second printed code that is only visible once the cable seal 330 (or a portion of the cable seal 330) has been removed. The second printed code may be chosen in a manner that prevents determining it based on the first printed code or any other externally visible markings on the cable seal 330. In some embodiments, the cable seal 330 may be designed such that the externally visible printed code is destroyed or disfigured when the cable seal 330 is removed, as described in more detail below with reference to FIG. 3C. The pallet 340 may thus be protected against being opened or tampered with in transit.

FIG. 3C is an illustrative diagram of a tamper-resistant label 360, which in some embodiments may form part of the cable seal 330 or other tamper-resistant materials described herein. The tamper-resistant label 360 adheres to an external package surface 350 by application of a strong adhesive layer 362, which may illustratively comprise any adhesive that provides sufficient adhesion to the package surface 350. In some embodiments, the strong adhesive layer 362 may contain two or more adhesives of varying strength, or a single adhesive applied intermittently, to form a pattern (e.g., the words “LABEL REMOVED” or “VOID”) that would remain visible on the external package surface 350 if tamper-resistant label 360 were removed.

Above the strong adhesive layer 362 is an internal label layer 364. The internal label layer 364 may contain a printed label, such as a QR code or bar code, that is hidden from view by subsequent layers of the tamper-resistant label 360. Illustratively, the recipient of a package secured by the tamper-resistant label 360 may initially verify that the internal label is not visible (which may indicate that the label has not been tampered with), and then remove one or more external layers to reveal the internal label and verify that the correct package has been delivered. In some embodiments the internal label layer may include light-sensitive paper or other materials that may indicate whether the internal label was exposed or revealed while the package was in transit.

In some embodiments, the tamper-resistant label 360 includes a weak adhesive layer 366 above the internal label layer 364, which may adhere all or part of the internal label layer 364 to an external label layer 368. Illustratively, as described above, the weak adhesive layer 366 may include multiple adhesives, or patterns of adhesive application, that create a visible mark, word, pattern, or other indication if and when the external label layer 368 is separated from the internal label layer 364. In further embodiments, the weak adhesive layer 366 may adhere to only a portion of the layers 364 and 368, such as the outer edges of the layers, and the external label layer 368 may be designed so that a portion of it does not adhere to the inner label layer 364, as described in more detail below. In other embodiments, the weak adhesive layer 366 may be omitted and the entire external label layer 368 may be removable. It will be understood that “strong” and “weak,” as used in reference to the strong adhesive layer 362 and the weak adhesive layer 366, may refer to properties of the adhesive and/or properties of the layer, and that in some embodiments the same adhesive may be used in both the strong adhesive layer 362 and the weak adhesive layer 366.

The external label layer 368 may include an external label, such as a second QR code or bar code, which is externally visible while the package is in transit and which differs from the hidden internal label. All or part of the entire external label layer 368 may be removable, and the recipient of the package may remove all or part of the layer 368 to reveal the internal code of the tamper-resistant label 360. For example, the external label layer 368 may have a perforated area 370 that the package recipient can remove to reveal the internal label.

Turning now to FIG. 3D, an example tamper-resistant bolt 380 will be described. The tamper-resistant bolt 380 may be used to seal a package in accordance with programs such as the Customs-Trade Partnership Against Terrorism (C-TPAT). As depicted, the tamper-resistant bolt 380 may include one or more labels or codes, such as bar codes or QR codes 384, that may be used to identify the bolt and associate it with a particular package. The tamper-resistant bolt 380 may also be utilized in conjunction with a zip tie that can include matching codes or supplemental codes.

FIG. 3D illustrates four primary views of the tamper-resistant bolt 380, as seen from the left, back, front, and top. The tamper-resistant bolt 380 includes a bolt head 382, which as shown comprises a rectangular box shape that becomes a cylinder at one end. Other shapes that provide a flat surface or surfaces for display of one or more QR codes 384 are within the scope of the present disclosure. The tamper-resistant bolt 380 further includes a bolt pin 386, which extends from the bottom of the bolt head 382. The bolt pin 386 may be any shape that enables sliding the bolt pin 386 through a latch (e.g., a door latch on a shipping container or truck trailer) and inserting it into the locking cylinder 388.

The tamper-resistant bolt 380 further includes the locking cylinder 388, which in the illustrated embodiment is similar in shape to the bolt head 382. It is not necessary that the locking cylinder 388 be similar in shape or appearance to the bolt head 382, and other shapes that provide one or more flat surfaces for display of QR codes 384 are within the scope of the present disclosure. The locking cylinder 388 includes a hole 390, into which the bolt pin 386 may be inserted. In the illustrated embodiment, the hole 390 is a cavity in the locking cylinder 388. In some embodiments, the hole 390 may pass all of the way through the locking cylinder 388, and a portion of the bolt pin 386 may extend below the locking cylinder 388 when the tamper-resistant bolt 380 is closed or locked. The locking cylinder 388 further includes one or more QR codes 384, which correspond to the QR codes 384 printed on the bolt head 382.

FIG. 4 is a flow diagram depicting an illustrative package sealing routine 400. The illustrative routine 400 may be carried out, for example, by the package sealing module 128 of FIG. 1. At block 402, a request may be received to seal a package. The request may illustratively be generated by a mobile computing device, such as the mobile computing device 110 of FIG. 1. In some embodiments, the request may be generated by scanning a QR code, sequence number, or other identifier of tamper-resistant materials as described above.

At block 404, sequence numbers of tamper-resistant packaging materials may be obtained. As described above, tamper-resistant packaging materials such as shrink wraps or pallet straps may be labeled with a sequence of codes or numbers. It will be understood that “sequence,” as used herein, may refer to any set of codes or numbers that enable determination of a starting position and an ending position within the packaging material, and is therefore not limited to a series of consecutive numbers. For example, the sequence numbers may be determined using a mathematical formula, or may be determined according to whether they satisfy a checksum, parity, or other criterion.

In some embodiments, a single sequence number may be obtained and may uniquely identify the packing material. For example, a packaging material (such as pallet lid 310 or tamper-resistant bolt 380) may be imprinted with a single sequence number. In other embodiments, as described above, sequence numbers may be reused if the probability of confusion is low. In further embodiments, as described above, blocks 402 and 404 may be combined, and receiving a sequence number or numbers of tamper-resistant packaging materials may be treated as a request to seal a package by using those materials.

At decision block 406, a determination may be made as to whether the sequence numbers obtained at block 404 are out of sequence. For example, a starting sequence number obtained at block 404 may be compared to an ending sequence number from a previous execution of the routine 400, and a determination may thus be made as to whether any of the tamper-resistant material has gone missing since the last time a package was sealed. If so, then at block 414 the missing materials may be invalidated, so that any package using these materials can be identified as not having been properly sealed. In some embodiments, at block 416, possible theft of (or tampering with) the tamper-resistant packaging material question may be reported, so that the gap in the sequence numbers can be investigated.

The routine 400 then proceeds to decision block 418, where a determination may be made as to whether the current user is a trusted user. For example, the user may be identified by a login, biometric identifier (e.g., a thumbprint or facial recognition), voiceprint, or other identification technique. The identified user may then be compared to a database of users to determine whether the user should be allowed to proceed with sealing the package despite the indication of possible tampering. If the determination is that the user is not a trusted user, then the routine 400 ends.

If the determination at decision block 418 is that the user is a trusted user, or if the determination that decision block 406 is that the sequence numbers are not out of sequence, then the routine 400 proceeds to block 408, where a sealed package record may be generated and stored. The sealed package record may illustratively include the sequence numbers that were obtained at block 404, which may be obtained from any number and type of tamper-resistant packaging materials. For example, the sealed package record may indicate that a package was sealed using shrink wrap that started at sequence number 12744 and ended at sequence number 12803, a pallet lid with sequence number 30385, pallet straps that started at sequence number 2713 and ended at sequence number 2734, and cable seals that had sequence numbers 13109 and 13110. As a further example, the sealed package record may include numerical or visual representations of QR codes or other codes that identify the tamper-resistant packaging materials used to seal the package.

At block 410, package monitoring criteria may be determined. For example, criteria may be determined based on a delivery location of the package, such as a delivery route that should be followed or a geographic area beyond which the package should not be taken. As a further example, criteria may be determined based on a specified delivery time or delivery window, and the criteria may measure timely progress toward the package destination. In some embodiments, as described above, the routine 400 may determine package monitoring criteria based on sensors in a delivery vehicle, such as weight or temperature sensors, or may determine criteria based on a delivery route or a set of scheduled pick-ups and deliveries. In further embodiments, the routine 400 may determine package monitoring criteria based on sensors in the mobile computing device, such as a GPS antenna, camera, microphone, gyroscope, or other sensor.

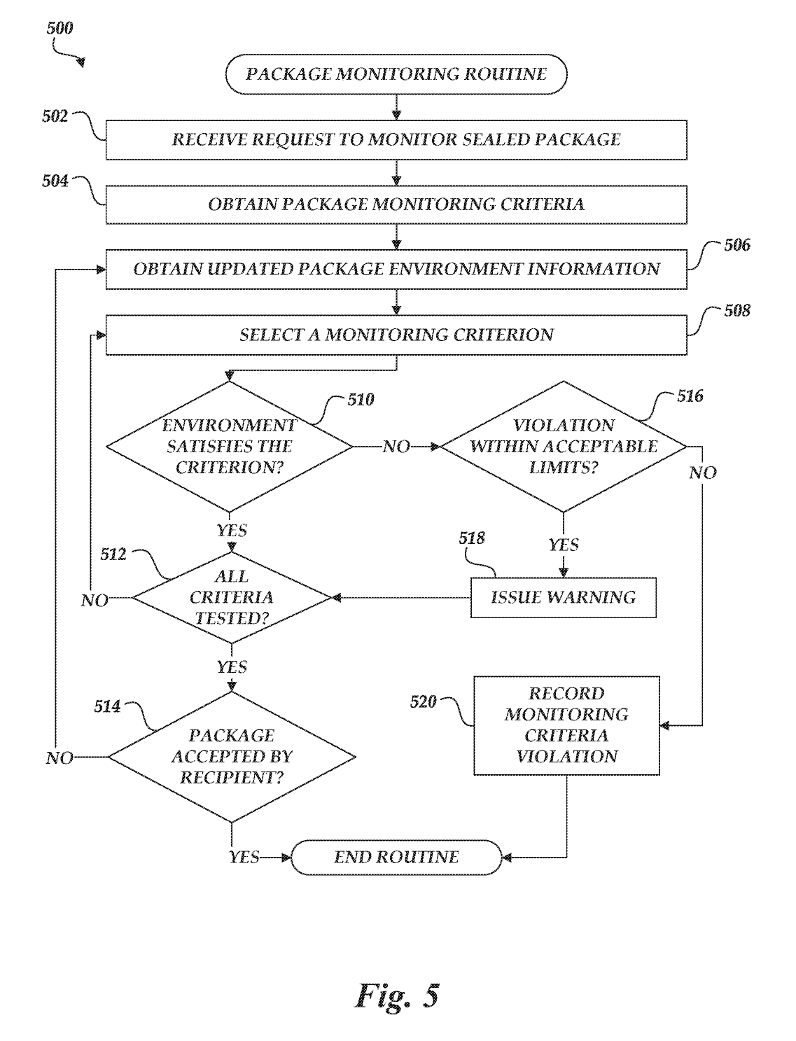

At block 412, package monitoring may be initiated based on the determined criteria. Illustratively, package monitoring may be initiated by carrying out a package monitoring routine, such as the routine 500 described below with reference to FIG. 5. In some embodiments, execution of the routine 400 may be carried out until package monitoring has been completed. In other embodiments, the routine 400 may end after invoking another routine that monitors the package while it is in transit.

It will be understood that FIG. 4 is provided for purposes of example, and that many variations on the illustrated routine 400 are within the scope of the present disclosure. For example, decision block 418 may be carried out prior to decision block 406, so that only trusted users are allowed to request sealing a package. As a further example, block 416 may be omitted and the routine 400 may omit reporting of possible tampering. Still further, block 410 may be carried out at any time prior to block 412, or block 408 may be carried out prior to decision block 406. The routine 400 is thus understood to be illustrative and not limiting.

FIG. 5 is a flow diagram depicting an illustrative package monitoring routine 500. The illustrative routine 500 may be carried out, for example, by the sealed package monitoring module 130 of FIG. 1. At block 502, a request to monitor a sealed package may be received. In some embodiments, the request may be received from a package sealing routine, such as the routine 400 depicted in FIG. 4. In other embodiments, the request to monitor a sealed package may be received and processed independently of a request to seal a package for transit. The request may identify the sealed package using a sequence number or numbers/codes from tamper-resistant packaging materials that were used to seal the package.

At block 504, package monitoring criteria may be obtained. In some embodiments, the package monitoring criteria may be included in the request at block 502, in which case block 504 may be omitted or combined with block 502. In other embodiments, the package monitoring criteria may be obtained from a data store, or may be determined based on characteristics of the package, delivery schedule, delivery location, or other factors.

At block 506, updated package environment information may be obtained. As described above, the updated package environment information may be obtained from sensors associated with the delivery vehicle, sensors associated with a mobile computing device (e.g., the mobile computing device 110 of FIG. 1), sensors on or associated with the package, or other sources. The updated package environment information may include, for example, geolocation information, temperature information, velocity information (e.g., a rate or direction of travel), weight information (e.g., a weight of the package or a gross weight of the delivery vehicle and/or its cargo area), time and date information, acceleration or g-force data, and so forth. In some embodiments, a partial update (e.g., information from a particular sensor) may be obtained.

At block 508, a monitoring criterion may be selected. Illustratively, a monitoring criterion may be selected from among the set of criteria that have not yet been evaluated against the updated package environment information. In some embodiments, a monitoring criterion may be selected based on the type of information obtained at block 506. For example, if the updated information at block 506 was received from a temperature sensor, then a monitoring criterion relating to temperature may be selected.

At decision block 510, a determination may be made as to whether the updated package environment information satisfies the monitoring criterion. For example, a monitoring criterion may specify that a particular delivery route be followed. The criterion may thus be satisfied by geolocation information that corresponds to a point on the delivery route. In some embodiments, the monitoring criterion may only be satisfied by a point on the delivery route that is closer to the destination (or further along the route) than a previously obtained geolocation. In further embodiments, the delivery route may specify a number of stops along the route, a rate of completion of the delivery route (or a time by which the route is expected to be completed), or other criteria that can be measured against the updated environment information. As a further example, the monitoring criterion may specify that the temperature of the package must be kept within a particular range, and the determination at decision block 510 may be as to whether the temperature is within that range. As still further examples, the monitoring criterion may specify that the package remain within a particular geographic area, or that it only leave the vehicle at the destination. In some embodiments, environment information may be received from multiple sources (e.g., from the package itself and from a delivery vehicle) and compared to assess whether the environment satisfies the criterion.

If the determination at decision block 510 is that the environment information does not satisfy the criterion, then at decision block 516 a determination may be made as to whether the violation of the criterion is within an acceptable limit. For example, the criterion may specify that the package is to be kept within a particular geographic area, and the determination at decision block 510 may be that the package is outside the specified area. The determination at decision block 516 may thus be based on how far (or for how long) the package has traveled outside the specified geographic area, and whether the violation can still be corrected by returning the package to the specified geographic area. As a further example, the criterion may specify that the package is to be kept within a particular temperature range, and the determination at decision block 510 may be that the package's current temperature is outside the range. The determination at decision block 516 may thus be based on whether the package has been exposed to the excessive temperature for long enough to cause damage or spoilage. In some embodiments, the package monitoring criteria obtained at block 504 may include criteria for determining whether a violation is within acceptable limits. In other embodiments, the determination may be made based on the type of criterion, a degree to which the criterion is unsatisfied, or other factors.

If the determination at decision block 516 is that the criteria violation is within an acceptable limit, then the routine 500 branches to block 518, where a warning may be issued. For example, a driver of a vehicle transporting the package may be given a warning to return to the delivery route, or may be warned that the driver is behind schedule and at risk of missing a package delivery window. In some embodiments, a warning may be issued to the sender of the package, alerting them that, for example, a package containing perishable items has been exposed to the elements, or that a fragile package has experienced sudden motion. The routine 500 then continues at decision block 512.

If the determination at decision block 516 is that the violation is not within acceptable limits, then at block 520 the violation of the monitoring criteria may be recorded. In some embodiments, the violation of the monitoring criteria may result in terminating the attempt to deliver the package. For example, if the determination is that the package will not be delivered within a required delivery window (or within an acceptable amount of time before or after the delivery window), then the delivery may be canceled or rescheduled. In other embodiments, the violation may be reported to, for example, the sender, the recipient, a manager of drivers or package delivery networks, or other parties.

After a warning is issued at block 518, or if the determination at decision block 510 is that the updated environment information satisfies the criterion, then at decision block 512 may determination is made as to whether all of the monitoring criteria have been tested. If not, then the routine 500 returns to block 508, selects another monitoring criterion, and iterates until either all of the criteria have been tested or a criteria violation is determined. In some embodiments, the routine 500 may iterate through all of the monitoring criteria regardless of whether an unacceptable violation is found with regard to one of the criteria. In such embodiments, the routine 500 may return to block 508 after block 520 is carried out.

If the determination at decision block 512 is that all of the criteria have been tested, then at decision block 514 determination is made as to whether the delivery has been completed and the package has been accepted by the recipient. If not, the routine 500 returns to block 506, were further updates to the package environment information may be obtained and measured against the monitoring criteria. In some embodiments, a determination may be made as to whether the recipient has explicitly rejected the package (e.g., because one or more monitoring criteria were violated in transit), and the routine 500 may end if so. If the package has not been explicitly accepted or rejected by the recipient, then the package delivery is considered to be still in progress, and the package monitoring routine 500 continues monitoring the package environment.

It will be understood that FIG. 5 is provided for purposes of example, and that many variations on the illustrated routine 500 are within the scope of the present disclosure. For example, blocks 516 and 518 may be omitted, and any violation of the package monitoring criteria may lead to recording a violation and ending the routine 500. As a further example, the routine 500 may end when the package environment information indicates that the package is at a particular location. Still further, in some embodiments, block 504 may be carried out after block 506, and the package monitoring criteria may be updated as the routine 500 is carried out. For example, the package monitoring criteria may be modified after the delivery vehicle crosses a state or national border, travels onto a particular road or highway, or satisfies other criteria. The package monitoring criteria may thus be dynamically updated to take into account road-specific or country-specific requirements, such as variations in speed limits or expected travel times. The routine 500 is thus understood to be illustrative and not limiting.

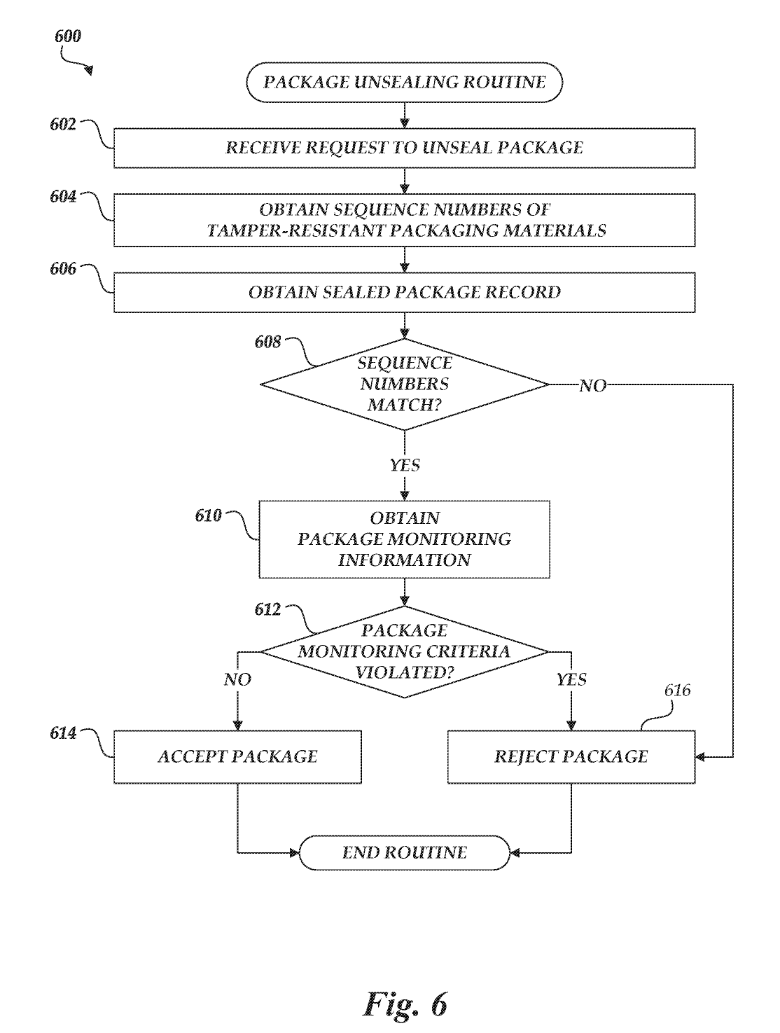

FIG. 6 is a flow diagram depicting an illustrative package verification routine 600. The illustrative routine 600 may be carried out, for example, by the package verification module 132 of FIG. 1. At block 602, a request may be received to unseal the package. The request may be received, for example, from the intended recipient of the package. In some embodiments, the request may be received from a driver or delivery agent.

At block 604, one or more sequence numbers of tamper-resistant packaging materials that were used to seal the package may be obtained. Illustratively, the sequence numbers may be obtained using a mobile computing device (such as the mobile computing device 110 of FIG. 1) that is equipped with a camera, scanner, wand, or other input device. In some embodiments block 602 and 604 may be combined, such that the request to unseal the package includes at least one sequence number from the tamper-resistant packaging materials. in other embodiments block 602 may be omitted, and obtaining sequence numbers may initiate the routine 600.

The block 606, a sealed package record may be obtained. The sealed package record may be obtained by, for example, searching a data store for a sealed package record that includes the sequence number(s). In some embodiments the sealed package record may be generated by a package sealing routine, such as the package sealing routine 400 of FIG. 4. At decision block 608, a determination may be made as to whether the sequence numbers obtained at block 604 match the sequence numbers in the sealed package record. Illustratively, all of the sequence numbers in the sealed package record should be obtainable at block 604 and should match. A mismatch of any of the sequence numbers would be an indication that some or all of the tamper-resistant packaging materials were damaged, removed, or tampered with during transit.

If the determination at decision block 608 is that the sequence numbers do not match, then at block 616 the package may be rejected. In some embodiments, a warning or notice may be provided to the sender, the recipient, the delivery agent, or other parties. For example, the notice may be provided to the recipient indicating that the package should be rejected due to tampering. In further embodiments, the recipient may be prompted to indicate whether they wish to reject the package given that the packaging materials have been tampered with. The routine 600 then ends.

If the determination at decision block 608 is that the sequence numbers match, then the routine 600 proceeds to block 610, where package monitoring information may be obtained. The obtained package monitoring information may, in some embodiments, be a summary of information collected by a package monitoring routine, such as the routine 500 depicted in FIG. 5. For example, the package monitoring information may include the route taken by a delivery vehicle, the range of temperatures to which the package was exposed, whether the package was subjected to any sudden movements or forces while in transit, whether the package was taken out of a specified geographic area, and so forth.

At decision block 612, a determination may be made as to whether package monitoring criteria were violated. In some embodiments, information regarding violations of package monitoring criteria may be obtained at block 610. In other embodiments, the package monitoring criteria may be obtained, and a comparison or comparisons between the package monitoring information and the package monitoring criteria may be made. In some embodiments, a further determination may be made as to whether violations of the package monitoring criteria were within acceptable limits, as described in more detail above.

If the determination at decision block 612 is that the package monitoring criteria have been unacceptably violated, then the routine 600 branches to block 616, where the package may be rejected as described above. If the determination at decision block 612 is instead that the package monitoring criteria have been satisfied, then the routine 600 branches to block 614, where the package may be accepted. In some embodiments, the recipient may be presented with information indicating that the package is acceptable and has not been detectably tampered with. In further embodiments, information may be provided to the sender or the delivery agent indicating that the package was delivered in accordance with specified criteria. The routine 600 then ends.

It will be understood that FIG. 6 is provided for purposes of example, and that many variations on the routine 600 are within the scope of the present disclosure. For example, block 606 may be carried out prior to block 602 or 604, and a sealed package record may be obtained for any package or packages that the recipient expects to receive. As a further example, decision block 608 may be carried out after decision block 612. The routine 600 is thus understood to be illustrative and not limiting.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

What is claimed is:

1. A system comprising:
a data store configured to store computer-executable instructions; and
a processor in communication with the data store, wherein the computer-executable instructions, when executed by the processor, configure the processor to:
receive, from a sender computing device, a request to securely deliver a package to a recipient, the request including information identifying a tamper-resistant packaging material used to seal the package, the information including at least a sender packaging material sequence number;
generate a sealed package record, wherein the sealed package record associates the sender packaging material sequence number with the package;
obtain a package monitoring criterion, the package monitoring criterion specifying a condition that must be satisfied while the package is in transit;
obtain, from a first sensor, first data associated with transit of the package;
determine that the first data satisfies the package monitoring criterion;
receive, from a second computing device associated with the recipient, a request to verify that the package has been securely delivered, the request including at least a recipient packaging material sequence number; and
determine that the recipient packaging material sequence number corresponds to the sender packaging material sequence number; and
generate and display to the recipient a notification that the package has been securely delivered.

2. The system of claim 1, wherein the processor is further configured to:
obtain, from the first sensor, second data associated with transit of the package, the second data obtained at a different time than the first data;
determine that the second data does not satisfy the package monitoring criterion;
determine that a difference between the second data and data satisfying the package monitoring criterion is within an acceptable limit; and
cause delivery of a notification regarding the difference.

3. The system of claim 2, wherein the notification is delivered to one or more of the sender, the recipient, or a delivery agent.

4. The system of claim 1, wherein the tamper-resistant packaging material comprises one or more of a shrink wrap, a pallet lid, a pallet strap, a cable seal, a bolt, or a label.

5. The system of claim 1, wherein the package monitoring criterion specifies a temperature, acceleration, time, duration, weight, velocity, delivery route, or geographic area.

6. A computer-implemented method comprising:
under control of a computing device configured with specific computer-executable instructions,
receiving, from a first computing device, a request to securely deliver a package, the request identifying at least a recipient and a tamper-resistant packaging material that is used to seal the package;
generating a sealed package record, wherein the sealed package record associates the package with the tamper-resistant packaging material;
monitoring at least one sensor while the package is in transit to determine that a package delivery criterion is satisfied;
receiving, from a second computing device, a request to verify that the package has been securely delivered, the request including information associated with the tamper-resistant packaging material;
determining that the package has been securely delivered based at least in part on the sealed package record, the information associated with the tamper-resistant packaging material, and the determination that the package delivery criterion is satisfied; and
causing display of a notification on the second computing device, the notification indicating that the package has been securely delivered.

7. The computer-implemented method of claim 6, wherein the first computing device is associated with at least one of a sender of the package or a delivery agent.

8. The computer-implemented method of claim 6 further comprising:
identifying, based at least in part on a packaging material sequence number associated with the package and a packaging material sequence number associated with a previous package, a missing portion of the tamper-resistant packaging material;
invalidating the missing portion of the tamper-resistant packaging material; and
causing display of a notification on the first computing device regarding the missing portion of the tamper-resistant packaging material.

9. The computer-implemented method of claim 6, wherein the tamper-resistant packaging material comprises at least one packaging material sequence number.

10. The computer-implemented method of claim 6 further comprising causing display of the notification on the first computing device.

11. The computer-implemented method of claim 6, wherein the sealed package record comprises a first packaging material sequence number, and wherein the information associated with the tamper-resistant packaging material comprises a second packaging material sequence number.

12. The computer-implemented method of claim 11, wherein determining that the package has been securely delivered comprises determining that the second packaging material sequence number corresponds to the first packaging material sequence number.

13. The computer-implemented method of claim 11, wherein the second packaging material sequence number is obtained from a hidden internal layer of a tamper-resistant label.

14. The computer-implemented method of claim 13, wherein determining that the package has been securely delivered comprises determining that the hidden internal layer of the tamper-resistant label was not exposed while the package was in transit.

15. The computer-implemented method of claim 6, wherein the request further identifies the package delivery criterion.

16. A non-transient computer-readable medium storing computer-executable instructions that, when executed by a computing device, configure the computing device to:
obtain information regarding a package to be securely delivered, the information identifying at least a tamper-resistant packaging material;
generate a sealed package record based at least in part on the information regarding the package to be securely delivered;
determine that transit of the package satisfied at least one delivery criterion;
receive a request to verify that the package has been securely delivered, the request including information associated with the tamper-resistant packaging material;
determine, based at least in part on the sealed package record, the delivery criterion that was satisfied during transit, and the information associated with the tamper-resistant packaging material, that the package has been securely delivered; and
cause the package to be accepted by a recipient.

17. The non-transient computer-readable medium of claim 16, wherein the request to verify that the package has been securely delivered is received from a computing device associated with the recipient.

18. The non-transient computer-readable medium of claim 16, wherein the request to verify that the package has been securely delivered is received from a computing device associated with a delivery agent.

19. The non-transient computer-readable medium of claim 16, wherein the sealed package record associates the package with the tamper-resistant packaging material.

20. The non-transient computer-readable medium of claim 16, wherein the computer-executable instructions configure the computing device to evaluate the at least one delivery criterion while the package is in transit.
